(19) United States
(12) Patent Application Publication
(10) Pub. No.: US 2025/0321622 A1
(43) Pub. Date: Oct. 16, 2025

(54) ELECTRONIC APPARATUS

(71) Applicant: Samsung Display Co., LTD., Yongin-si (KR)

(72) Inventor: IN SOO PARK, Yongin-si (KR)

(21) Appl. No.: 19/031,521

(22) Filed: Jan. 18, 2025

(30) Foreign Application Priority Data
Apr. 11, 2024 (KR) 10-2024-0048575

(51) Int. Cl. G06F 1/16

(52) U.S. Cl. CPC G06F 1/1656; G06F 1/1616; G06F 1/1643

(57) ABSTRACT

An electronic apparatus includes a display module including a foldable region foldable with respect to a folding axis, and a first non-folding region and a second non-folding region which are spaced apart from each other, and a support plate disposed below the display module and including a first plate overlapping the first non-folding region, a second plate overlapping the second non-folding region, and a support member overlapping the foldable region. The support member includes a barrier layer disposed below the display module, a foldable adhesive layer disposed under the barrier layer, and a foldable plate disposed under the foldable adhesive layer. The width of the foldable adhesive layer is smaller than the width of the barrier layer and is greater than the width of the foldable plate.

This application claims priority to Korean Patent Application No. 10-2024-0048575, filed on Apr. 11, 2024, and all the benefits accruing therefrom under 35 U.S.C. § 119, the content of which in its entirety is herein incorporated by reference.

### BACKGROUND

The present disclosure herein relates to a foldable electronic apparatus.

Various electronic apparatuses such as a television, a mobile phone, a tablet computer, and a game console are being developed. Recently, flexible electronic apparatuses including a flexible display panel which is slidable or foldable are being developed. Unlike a rigid display apparatus, the flexible electronic apparatus may be foldable, rollable, or bendable. The flexible electronic apparatus deformable into various shapes may be portable regardless of a typical display screen size, thereby improving user convenience.

When a foldable electronic apparatus among flexible electronic apparatuses is folded, it is desirable to maintain reliability and stability of members constituting the electronic apparatus.

### SUMMARY

The present disclosure provides an electronic apparatus in which stress may be prevented from concentrating on a display module during folding.

An embodiment of the invention provides an electronic apparatus including: a display module including a foldable region foldable with respect to a folding axis extending along a first direction, and a first non-folding region and a second non-folding region which are spaced apart along a second direction crossing the first direction with the foldable region therebetween; a window disposed on the display module; and a support plate disposed below the display module, and including a first plate overlapping the first non-folding region, a second plate overlapping the second non-folding region, and a support member overlapping the foldable region, where the support member includes a barrier layer disposed below the display module, a foldable adhesive layer disposed under the barrier layer, and a foldable plate disposed under the foldable adhesive layer, and a width of the foldable adhesive layer in the second direction is smaller than a width of the barrier layer, and greater than a width of the foldable plate.

In an embodiment, the foldable plate may provide a plurality of holes defined therein, which penetrates from a front surface and to a rear surface of the foldable plate.

In an embodiment, the foldable adhesive layer may include: a first portion disposed adjacent to the first non-folding region and not overlapping the plurality of holes; and a second portion spaced apart from the first portion with the plurality of holes therebetween and disposed adjacent to the second non-folding region.

In an embodiment, the first plate, the second plate, and the foldable plate may include one of a metal and a reinforced fiber composite material.

In an embodiment, one end of the barrier layer may overlap the first non-folding region, and the other end of the barrier layer in the second direction may overlap the second non-folding region.

In an embodiment, the first plate may include a first portion having a first thickness, and a second portion which protrudes from the first portion toward a boundary between the first non-folding region and the foldable region and has a second thickness smaller than the first thickness, the second plate may include a third portion having the first thickness, and a fourth portion which protrudes from the third portion toward a boundary between the second non-folding region and the foldable region and has the second thickness, a first stepped portion may be defined by the first portion and the second portion, and a second stepped portion may be defined by the third portion and the fourth portion, and one end of the barrier layer may be disposed inside the first stepped portion, and the other end of the barrier layer in the second direction may be disposed inside the second stepped portion.

In an embodiment, the second portion facing the one end and the fourth portion facing the other end may have curved surfaces, respectively, and the one end and the other end of the barrier layer facing the curved surfaces may be curved so as to correspond to the curved surfaces.

In an embodiment, the electronic apparatus may further include an in-between adhesive layer disposed between the display module and the support plate.

In an embodiment, the in-between adhesive layer may include: a first portion overlapping the first plate; a second portion overlapping the second plate, and a foldable portion disposed between the first portion and the second portion and spaced apart from the first portion and the second portion.

In an embodiment, a width of the foldable portion in the second direction may be smaller than a width of the barrier layer.

In an embodiment, the folding axis may be defined on an upper surface of the window, and the electronic apparatus may be in-folded such that a part of the upper surface of the window overlapping the first non-folding region and a part of the upper surface of the window overlapping the second non-folding region face each other in a first mode, and face the same direction in a second mode.

In an embodiment, the folding axis may be defined below a rear surface of the support plate, and the electronic apparatus may be in-folded such that a rear surface of the first plate and a rear surface of the second plate face each other in a first mode, and face the same direction in a second mode.

In an embodiment, the electronic apparatus may further include an optical layer disposed between the window and the display module, where the optical layer may include at least one of a retarder, a polarizer, a polarization film, a polarization filter, or a color filter.

In an embodiment, the display module may include: a display panel including pixels; and an input-sensing layer disposed on the display panel.

In an embodiment, the display panel may include a base layer, a circuit layer disposed on the base layer, a display element layer disposed on the circuit layer, and an encapsulation layer covering the display element layer, and the input-sensing layer may be directly disposed on the encapsulation layer.

In an embodiment, the display panel may include: a first region overlapping the first non-folding region, the foldable region, and the second non-folding region; a second region arranged along the second direction with the first region; and a bending region disposed between the first region and the second region, and the bending region may be bent with respect to a bending axis extending along the first direction and different from the folding axis.

In an embodiment, the barrier layer may include a flexible plastic material.

In an embodiment, the foldable adhesive layer may include at least one of a pressure sensitive adhesive (“PSA”), an optically clear adhesive (“OCA”), or an optical clear resin (“OCR”).

In an embodiment, the maximum thickness of the support member may be greater than each of thicknesses of the first plate and the second plate.

In an embodiment, a thickness of the foldable plate may be the same as each of thicknesses of the first plate and the second plate.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view illustrating an electronic apparatus of an embodiment;

FIG. 1B is a perspective view illustrating an electronic apparatus of an embodiment;

FIG. 1C is a perspective view illustrating an electronic apparatus of an embodiment;

FIG. 1D is a perspective view illustrating an electronic apparatus of an embodiment;

FIG. 2A is a perspective view illustrating an electronic apparatus according to an embodiment;

FIG. 2B is a perspective view illustrating an electronic apparatus according to an embodiment;

FIG. 2C is a perspective view illustrating an electronic apparatus according to an embodiment;

FIG. 3 is an exploded perspective view illustrating an electronic apparatus of an embodiment;

FIG. 4 is a cross-sectional view illustrating a portion taken along line I-I′ of FIG. 3;

FIG. 5 is a plan view of a display panel according to an embodiment;

FIG. 6 is a cross-sectional view of an electronic apparatus according to an embodiment;

FIG. 7 is a cross-sectional view of an electronic apparatus according to another embodiment;

FIG. 8 is a cross-sectional view of an electronic apparatus according to still another embodiment;

FIG. 9 is a cross-sectional view of an electronic apparatus according to yet another embodiment; and

FIG. 10 is a cross-sectional view of an electronic apparatus according to still another embodiment.

### DETAILED DESCRIPTION

In this specification, it will be understood that when an element (or region, layer, portion, or the like) is referred to as being “on”, “connected to” or “coupled to” another element, it may be directly disposed/connected/coupled to another element, or intervening elements may be disposed therebetween.

Like reference numerals or symbols refer to like elements throughout. Also, in the drawings, the thicknesses, the ratios, and the dimensions of the elements are exaggerated for effective description of the technical contents. The term “and/or” includes all of one or more combinations defined by the associated elements.

Although the terms “first”, “second”, etc., may be used to describe various elements, these elements should not be limited by these terms. These terms are only used to distinguish one element from another element. For example, a first element may be referred to as a second element, and similarly, a second element may also be referred to as a first element without departing from the scope of the invention. The singular forms include the plural forms as well, unless the context clearly indicates otherwise.

Also, the terms such as “below”, “lower”, “above”, “upper” and the like, may be used for the description to describe one element's relationship to another element illustrated in the figures. It will be understood that the terms have a relative concept and are described on the basis of the orientation depicted in the figures.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Unless otherwise defined, all terms (including technical and scientific terms) used herein have the same meaning as commonly understood by one of ordinary skill in the art to which the present disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

Throughout the disclosure, the expression “at least one of a, b or c” indicates only a, only b, only c, both a and b, both a and c, both b and c, all of a, b, and c, or variations thereof. Hereinafter, embodiments of the invention will be described with reference to the drawings.

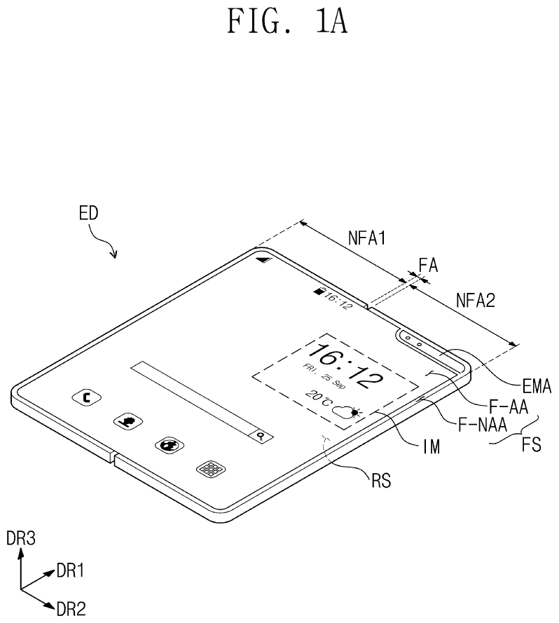

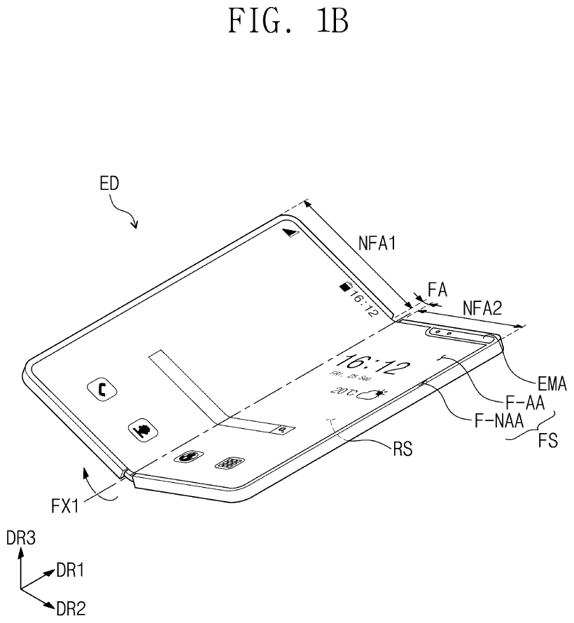

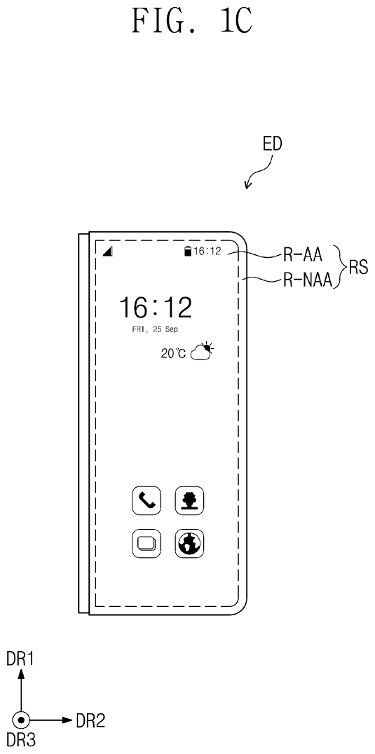

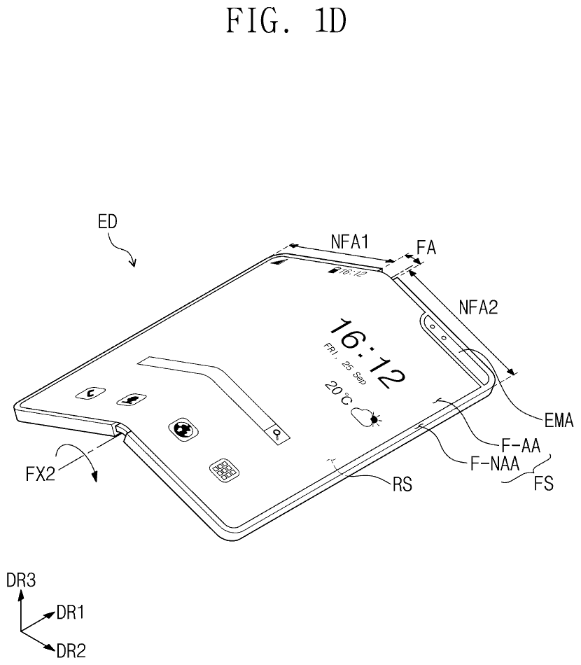

FIG. 1A is a perspective view illustrating an electronic apparatus of an embodiment. FIG. 1B is a perspective view illustrating an electronic apparatus of an embodiment. FIG. 1C is a perspective view illustrating an electronic apparatus of an embodiment. FIG. 1D is a perspective view illustrating an electronic apparatus of an embodiment.

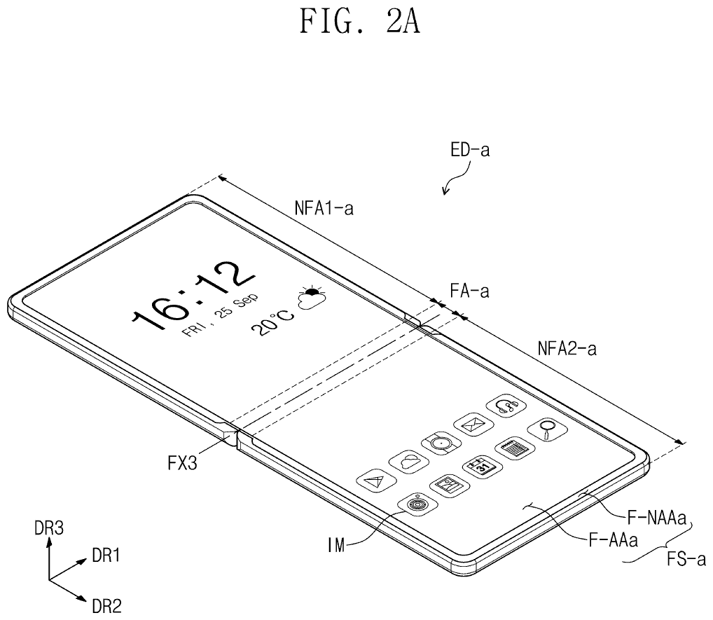

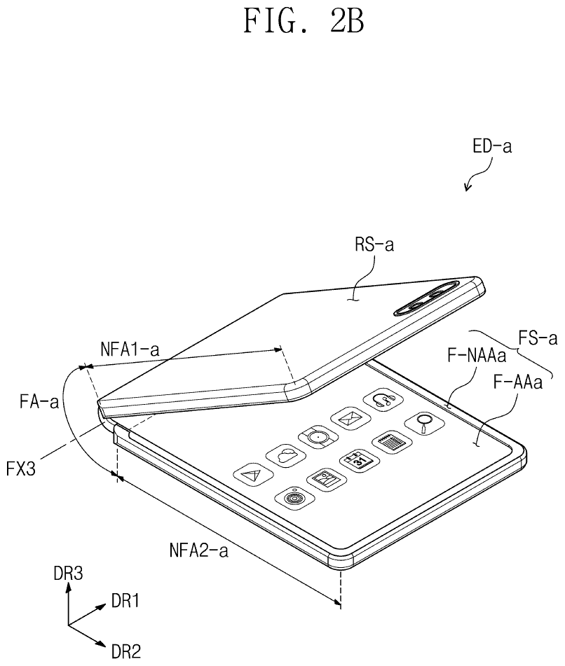

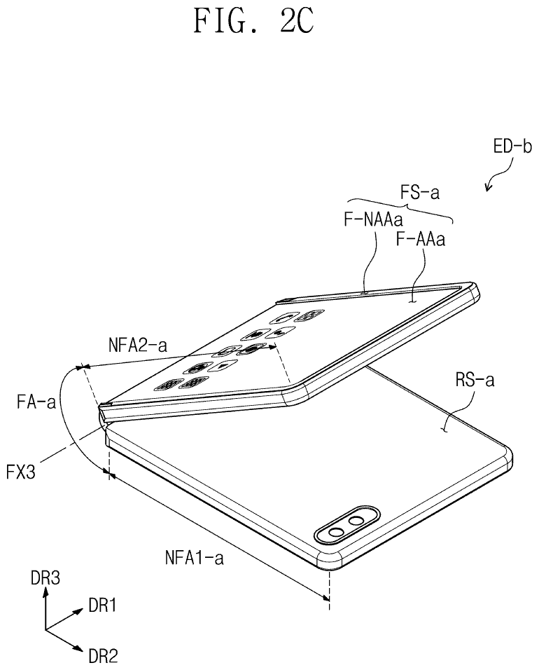

FIG. 1A is a perspective view illustrating a state in which an electronic apparatus ED according to an embodiment is unfolded. The electronic apparatus ED of an embodiment may be activated in response to an electrical signal. For example, the electronic apparatus ED may be a mobile phone, a tablet computer, a car navigation system, a game console, or a wearable device, but an embodiment of the invention is not limited thereto. FIGS. 1A to 2C exemplarily illustrate foldable electronic apparatuses ED and ED-a. The foldable electronic apparatuses ED and ED-a according to embodiments may be mobile phones.

The electronic apparatus ED may include a first display surface FS defined by a first direction axis DR1 and a second direction axis DR2 crossing the first direction axis DR1. The electronic apparatus ED may provide an image IM to a user through the first display surface FS. The electronic apparatus ED may display the image IM, in the direction of a third direction axis DR3, on the first display surface FS parallel to each of the first direction axis DR1 and the second direction axis DR2.

In this specification, the first direction axis DR1 and the second direction axis DR2 may be orthogonal to each other, and the third direction axis DR3 may be a normal direction of a plane defined by the first direction axis DR1 and the second direction axis DR2. A thickness direction of the electronic apparatus ED may be a direction parallel to the third direction axis DR3. A front surface (or upper surface) and a rear surface (or lower surface) may be opposed to each other in the third direction axis DR3, and a normal direction of each of the front surface (or upper surface) and the rear surface (or lower surface) may be parallel to the third direction axis DR3. The front surface (or upper surface) is referred to as a surface close to the first display surface FS, and the rear surface (or lower surface) is referred to as a surface opposed to the first display surface FS. Also, the rear surface (or lower surface) is referred to as a surface close to a second display surface RS to be described later. An upper side (or upper part) is referred to as a side or part in a direction of getting closer to the first display surface FS, and a lower side (or lower part) is referred to as a side or part in a direction of getting farther away from the first display surface FS.

A cross section of components is referred to as a surface parallel to the third direction DR3 which is a thickness direction, and a plane is referred to as a surface perpendicular to the third direction DR3 which is a thickness direction. A plane is referred to as a surface defined by the first direction axis DR1 and the second direction axis DR2.

The directions indicated by the first to third direction axes DR1, DR2, and DR3 illustrated herein have a relative concept, and may thus be changed to other directions. In addition, the directions indicated by the first to third direction axes DR1, DR2, and DR3 may be referred to as first to third directions, and may be denoted as the same reference numerals or symbols.

The electronic apparatus ED may detect an external input applied from the outside. The external input may include various types of inputs applied from the outside of the electronic apparatus ED. For example, the external input may include not only a touch by a part of a user's body such as user's hands but also an external input (for example, hovering) applied while approaching or being adjacent within a predetermined distance to the electronic apparatus ED. Additionally, the external input may have various types such as force, pressure, temperature, light, etc.

The electronic apparatus ED may include the first display surface FS and the second display surface RS. The first display surface FS may include a first active region F-AA, a first peripheral region F-NAA, and an electronic module region EMA. The second display surface RS may be defined as a surface opposed to at least a portion of the first display surface FS. That is, the second display surface RS may be defined as a portion of the rear surface of the electronic apparatus ED.

The first active region F-AA may be activated in response to an electrical signal. The first active region F-AA may be a region in which the image IM is displayed and various types of external inputs are detected.

The first peripheral region F-NAA may be a region in which the image IM is not displayed. The first peripheral region F-NAA may be adjacent to the first active region F-AA. The first peripheral region F-NAA may have a predetermined color. The first peripheral region F-NAA may surround the first active region F-AA. Accordingly, a shape of the first active region F-AA may be substantially defined by the first peripheral region F-NAA. However, this is exemplarily illustrated. The first peripheral region F-NAA may be disposed adjacent to only one side of the first active region F-AA, or may be omitted.

Various electronic modules may be disposed in the electronic module region EMA. For example, the electronic module may include at least one of a camera, a speaker, a light detection sensor, or a heat detection sensor. The electronic module region EMA may detect an external subject received through the display surfaces FS and RS or provide a sound signal such as voice to the outside through the display surfaces FS and RS. The electronic module may include a plurality of components, and is not limited to any one embodiment.

The electronic module region EMA may be surrounded by the first peripheral region F-NAA. However, this is presented as an example, and the electronic module region EMA is not limited to any one embodiment. For another example, the electronic module region EMA may be surrounded by the first active region F-AA and the first peripheral region F-NAA, and may be disposed within the first active region F-AA.

The electronic apparatus ED according to an embodiment may be divided into at least one foldable region FA, and a plurality of non-folding regions NFA1 and NFA2 extending from the foldable region FA. For example, a first non-folding region NFA1, the foldable region FA, and a second non-folding region NFA2, which are arranged along the second direction DR2 may be defined. The electronic apparatus ED may be divided into the first non-folding region NFA1 and the second non-folding region NFA2 spaced apart from each other in the second direction DR2 with the foldable region FA therebetween. For example, the first non-folding region NFA1 may be disposed on one side of the foldable region FA in the second direction DR2, and the second non-folding region NFA2 may be disposed on the other side of the foldable region FA in the second direction DR2.

FIG. 1A, etc., illustrate the electronic apparatus ED, of an embodiment, including one foldable region FA, but an embodiment of the invention is not limited thereto. A plurality of foldable regions may be defined in the electronic apparatus ED. For example, the electronic apparatus according to an embodiment may include two or more foldable regions, and also may include three or more non-foldable regions disposed with foldable regions therebetween, respectively.

FIG. 1B is a perspective view illustrating a folding operation of the electronic apparatus ED according to an embodiment. FIG. 1C is a plan view illustrating a state in which the electronic apparatus ED according to an embodiment is folded. FIG. 1D is a perspective view illustrating a folding operation of the electronic apparatus ED according to an embodiment. As used herein, the plan view is a view in a thickness direction (third direction DR3) of the electronic device ED.

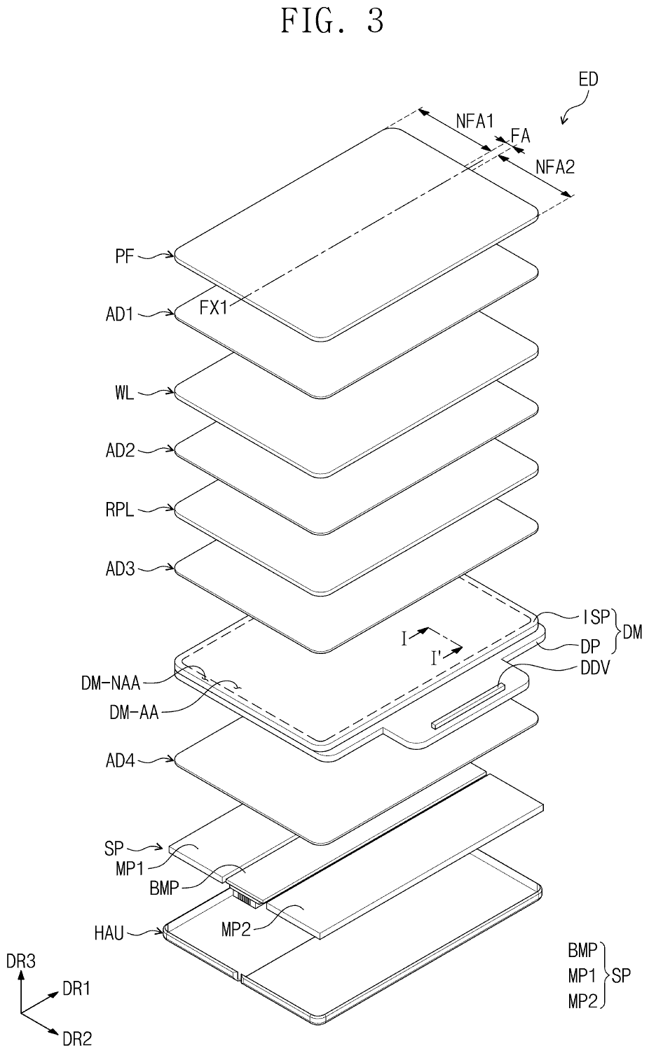

Referring to FIG. 1B, the electronic apparatus ED according to an embodiment may be folded with respect to a first folding axis FX1 extending in the first direction DR1. In a state in which the electronic apparatus ED is folded, the foldable region FA may have a predetermined curvature and a radius of a curvature. In this embodiment, the first folding axis FX1 may be defined to be disposed on an upper surface of a window WL (see FIG. 3). The electronic apparatus ED may be folded with respect to the first folding axis FX1, and be changed into an in-folded state such that the first non-folding region NFA1 and the second non-folding region NFA2 face each other and the first display surface FS is not exposed to the outside. According to this embodiment, the electronic apparatus ED may be in-folded in a first mode such that upper surfaces of the window WL overlapping the first non-folding region NFA1 and the second non-folding region NFA2 face each other, and may be unfolded in a second mode as illustrated in FIG. 1A.

Referring to FIG. 1C, the second display surface RS of the electronic apparatus ED according to an embodiment may be visible to users in an in-folded state. In this case, the second display surface RS may include a second active region R-AA which displays images. The second active region R-AA may be activated in response to an electrical signal. The second active region R-AA may be a region in which the image is displayed and various types of external inputs are detected.

The second display surface RS may include a second peripheral region R-NAA. The second peripheral region R-NAA may be adjacent to the second active region R-AA. The second peripheral region R-NAA may have a predetermined color. The second peripheral region R-NAA may surround the second active region R-AA. Also, although not illustrated, the electronic apparatus ED may further include, also in the second display surface RS, an electronic module region in which an electronic module including various components is disposed, and is not limited to any one embodiment.

According to an embodiment, in a state in which the electronic apparatus ED is in-folded, a distance between the first non-folding region NFA1 and the second non-folding region NFA2 may be smaller than a radius of circle defined by a radius of a curvature of the foldable region FA. In this case, the foldable region FA may be folded in a dumbbell-like shape, and the distance between the first non-folding region NFA1 and the second non-folding region NFA2 may become even shorter. Therefore, it is possible to provide a slimmer electronic apparatus ED in a folded state.

Referring to FIG. 1D, the electronic apparatus ED according to an embodiment may be folded with respect to a second folding axis FX2 extending in the first direction DR1. In this embodiment, the second folding axis FX2 may be defined to be disposed below a rear surface of a support plate SP (see FIG. 3). The electronic apparatus ED may be folded with respect to the second folding axis FX2, and be changed into an out-folded state such that the first display surface FS is exposed to the outside. According to this embodiment, the electronic apparatus ED may be out-folded in the first mode such that a first plate MP1 (see FIG. 3) and a second plate MP2 (see FIG. 3) face each other, and may be unfolded in the second mode as illustrated in FIG. 1A.

FIGS. 1A to 1D exemplarily illustrate that the electronic apparatus ED is folded with respect to one folding axis (FX1 or FX2), but the number of folding axes and the number of non-foldable regions corresponding to the number of folding axes are not particularly limited thereto. For example, the electronic apparatus ED may be folded with respect to a plurality of folding axes such that respective portions of the first display surface FS and the second display surface RS face each other. Also, it is illustrated that the first and second folding axes FX1 and FX2 are parallel to a long side of the electronic apparatus ED, but an embodiment of the invention is not limited thereto. In another embodiment, the first and second folding axes FX1 and FX2 may be parallel to a short side of the electronic apparatus ED.

In a state in which the electronic apparatus ED is folded as illustrated in FIG. 1C, the first non-folding region NFA1 and the second non-folding region NFA2 may be defined as portions having the display surfaces FS and RS parallel to a plane defined by the first direction axis DR1 and the second direction axis DR2, and the foldable region FA may be defined as a region between the first non-folding region NFA1 and the second non-folding region NFA2. The foldable region FA may have a curved portion which is curved so as to have a predetermined curvature in a folded state.

FIG. 2A is a perspective view illustrating an electronic apparatus according to an embodiment. FIG. 2B is a perspective view illustrating an electronic apparatus according to an embodiment. FIG. 2C is a perspective view illustrating an electronic apparatus according to an embodiment.

FIGS. 2A to 2C are perspective views illustrating an electronic apparatus ED-a according to another embodiment of the invention. FIG. 2A is a perspective view illustrating the electronic apparatus ED-a in an unfolded state. FIGS. 2B and 2C are perspective views illustrating a folding operation of the electronic apparatus ED-a. FIG. 2B is a perspective view illustrating an in-folding operation of the electronic apparatus ED-a illustrated in FIG. 2A. FIG. 2C is a perspective view illustrating an out-folding operation of the electronic apparatus ED-a illustrated in FIG. 2A. FIG. 2A may be a view illustrating the electronic apparatus ED-a in the second mode.

Referring to FIG. 2A, the electronic apparatus ED-a may be folded with respect to a third folding axis FX3 extending along the first direction DR1. An extending direction of the third folding axis FX3 may be parallel to an extending direction of a short side of the electronic apparatus ED-a.

The electronic apparatus ED-a may be divided into a foldable region FA-a, a first non-folding region NFA1-a adjacent to one side of the foldable region FA-a, and a second non-folding region NFA2-a adjacent to the other side of the foldable region FA-a. The first non-folding region NFA1-a and the second non-folding region NFA2-a may be spaced apart from each other with the foldable region FA-a therebetween.

The foldable region FA-a may be folded with respect to the third folding axis FX3. In a state in which the electronic apparatus ED-a is folded, the foldable region FA-a may have a predetermined curvature and a radius of a curvature. The first non-folding region NFA1-a and the second non-folding region NFA2-a may face each other, and the electronic apparatus ED-a may be in-folded such that the display surface FS is not exposed to the outside.

Referring to FIG. 2A, in an embodiment, a display surface FS-a of the electronic apparatus ED-a may be visible to a user in an unfolded state (second mode). As described with references to FIGS. 1A to 1D, the display surface FS-a of the electronic apparatus ED-a may include an active region F-AAa and a peripheral region F-NAAa. The active region F-AAa may be a region in which the image IM is displayed and various types of external inputs are detected.

Referring to FIG. 2B, a rear surface RS-a of the electronic apparatus ED-a of an embodiment may be visible to a user in an in-folded state. For example, the rear surface RS-a may function as a second display surface on which a video or image is displayed. Additionally, an electronic module region, in which an electronic module including various components is disposed, may be disposed also in the rear surface RS-a. According to an embodiment, the rear surface RS-a of the electronic apparatus ED-a may further include an active region on which images are displayed.

Referring to FIG. 2C, the electronic apparatus ED-a may be folded with respect to the third folding axis FX3 and be changed into an out-folded state in which among the rear surface RS-a, one region overlapping the first non-folding region NFA1-a and the other region overlapping the second non-folding region NFA2-a face each other.

FIG. 3 is an exploded perspective view illustrating an electronic apparatus of an embodiment.

Referring to FIG. 3, an electronic apparatus ED may include a protective layer PF, a window WL, an optical layer RPL, a display module DM, a support plate SP, and a housing HAU.

The housing HAU may be coupled to the protective layer PF and the window WL to define the exterior of the electronic apparatus ED. The housing HAU may include a material having relatively high rigidity. For example, the housing HAU may include a plurality of frames and/or support plates composed of glass, plastic, or metal. The housing HAU may provide a predetermined accommodation space. The display module DM may be accommodated inside the accommodation space and be protected against an external impact.

The display module DM may be activated in response to an electrical signal. The display module DM may be activated to display the image IM (see FIG. 1A) on the active region F-AA (see FIG. 1A) of the electronic apparatus ED. A display region DM-AA and a non-display region DM-NAA may be defined in the display module DM. The display region DM-AA may be activated in response to an electrical signal. The non-display region DM-NAA may be located adjacent to at least one side of the display region DM-AA. A circuit, a line, etc., for driving the display region DM-AA may be disposed in the non-display region DM-NAA.

The optical layer RPL may be disposed between the display module DM and the window WL. The optical layer RPL may be an anti-reflective layer which reduces reflectance for external light incident from the outside of the display module DM. The optical layer RPL may be formed on the display module DM through a continuous process. The optical layer RPL may include a polarization plate or a color filter layer. For example, the optical layer RPL may include at least one of a retarder, a polarizer, a polarization film, or a polarization filter. Alternatively, the optical layer RPL may include a plurality of color filters disposed in a predetermined arrangement and a black matrix adjacent to the color filters. In the electronic apparatus ED according to an embodiment, the optical layer RPL and a third adhesive layer AD3 may be omitted, and the electronic apparatus ED is not limited to any one embodiment.

The image IM (see FIG. 1A) generated from the display module DM may pass through the window WL and be provided to a user. The window WL may include an optically transparent insulating material. The window WL may include a polymer substrate or a glass substrate.

The window WL may be formed of polyimide, polyacrylate, polymethylmethacrylate, polycarbonate, polyethylene naphthalate, polyvinylidene chloride, polyvinylidene difluoride, polystyrene, an ethylene-vinyl alcohol copolymer, or a combination thereof.

However, this is presented as an example, and a material included in the window WL is not limited thereto. For another example, the window WL may be a tempered glass substrate which has been subjected to reinforcement treatment. The window WL may include ultra-thin glass (“UTG”).

The protective layer PF may be a functional layer which protects one surface of the window WL. The protective layer PF may include a polymer film. The protective layer PF may include an anti-fingerprint coating agent, a hard coating agent, an antistatic agent, etc.

The support plate SP may be disposed below a display panel DP. A portion of the support plate SP according to the invention may be bent to absorb an impact applied between the housing HAU and components disposed on the support plate SP. Additionally, the support plate SP may prevent foreign substances, etc., from being introduced into the components disposed on the support plate SP.

The support plate SP may include a first plate MP1 disposed in the first non-folding region NFA1, a second plate MP2 disposed in the second non-folding region NFA2, and a support member BMP disposed between the first plate MP1 and the second plate MP2 and overlapping the foldable region FA.

The electronic apparatus ED according to an embodiment may include at least one of a cushion layer or a shielding layer. The cushion layer may prevent the support plate SP from being dented and plastically deformed due to an external impact and force. The cushion layer may include an elastomer such as a sponge, a foam, or a urethane resin. Additionally, the cushion layer may be formed to include at least one of an acryl-based polymer, a urethane-based polymer, a silicone-based polymer, or an imide-based polymer. The shielding layer may be an electromagnetic wave shielding layer or a heat dissipation layer.

The electronic apparatus ED according to an embodiment may further include first to fourth adhesive layers AD1 to AD4. The first adhesive layer AD1 may be disposed between the window WL and the protective layer PF. The second adhesive layer AD2 may be disposed between the optical layer RPL and the window WL. The third adhesive layer AD3 may be disposed between the display module DM and the optical layer RPL. The fourth adhesive layer AD4 may be disposed between the support plate SP and the display module DM.

The first to fourth adhesive layers AD1 to AD4, and the adhesive layers to be described later may each include a typical bonding agent such as a pressure sensitive adhesive (PSA), an optically clear adhesive (OCA), and an optical clear resin (OCR), and are not limited to any one embodiment. In the electronic apparatus ED according to an embodiment, at least one among the first to fourth adhesive layers AD1 to AD4 may be omitted.

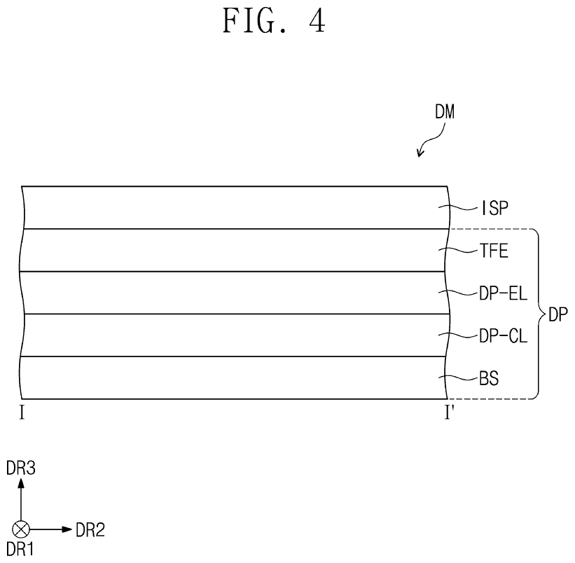

Referring to FIG. 4, a display module DM may include a display panel DP and an input-sensing layer ISP disposed on the display panel DP. The display panel DP may be configured to substantially generate an image. The display panel DP may be a light-emitting display panel. For example, the display panel DP may be an organic light-emitting display panel, an inorganic light-emitting display panel, a micro LED display panel, a micro OLED display panel, or a nano LED display panel.

The display panel DP may include a base layer BS, a circuit layer DP-CL, a display element layer DP-EL, and an encapsulation layer TFE, which are sequentially stacked. Unlike what is illustrated in the drawing, a functional layer may be further disposed between two adjacent layers among the base layer BS, the circuit layer DP-CL, the display element layer DP-EL, and the encapsulation layer TFE.

The base layer BS may provide a base surface on which the circuit layer DP-CL is disposed. The base layer BS may be a flexible substrate which is bendable, foldable, rollable, etc. The base layer BS may be a glass substrate, a metal substrate, a polymer substrate, etc. However, an embodiment of the invention is not limited thereto, and the base layer BS may include an inorganic layer, an organic layer, or a composite material layer in another embodiment.

The base layer BS may have a single- or multi-layered structure. For example, the base layer BS may include a first synthetic resin layer, a multi- or single-layered inorganic layer, or a second synthetic resin layer disposed on the multi- or single-layered inorganic layer. The first synthetic resin layer and the second synthetic resin layer may each include a polyimide-based resin. Additionally, the first synthetic resin layer and the second synthetic resin layer may each include at least one of an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, or a perylene-based resin. In this specification, a “˜˜based” resin may be considered as including a functional group of “˜˜”.

The circuit layer DP-CL may be disposed on the base layer BS. The circuit layer DP-CL may include an insulating layer, semiconductor patterns, conductive patterns, a signal line, etc. The display element layer DP-EL may be disposed on the circuit layer DP-CL. The display element layer DP-EL may include a light-emitting element (not illustrated). For example, the light-emitting element may include an organic light-emitting material, an inorganic light-emitting material, an organic-inorganic light-emitting material, quantum dots, quantum rods, a micro LED, or a nano LED.

The encapsulation layer TFE may be disposed on the display element layer DP-EL. The encapsulation layer TFE may protect the display element layer DP-EL against moisture, oxygen, and foreign substances such as dust particles. The encapsulation layer TFE may include at least one inorganic layer. For example, the encapsulation layer TFE may include an inorganic layer, an organic layer, and an inorganic layer which are sequentially stacked.

The input-sensing layer ISP may be disposed on the display panel DP. The input-sensing layer ISP may be directly disposed on the encapsulation layer TFE. Alternatively, an adhesive member may be disposed between the input-sensing layer ISP and the display panel DP.

In this specification, when an element is referred to as being directly disposed on another element, there is no intervening element therebetween. That is, the wording, “an element is ‘directly disposed on’ another element” means that the element is “in contact with” the other element.

The input-sensing layer ISP may detect an external input, change the detected external input to a predetermined input signal, and provide the input signal to the display panel DP. For example, the input-sensing layer ISP may be a touch-sensing layer which detects a touch. The input-sensing layer ISP may recognize a direct touch by a user, an indirect touch by a user, a direct touch by an object, or an indirect touch by an object.

The input-sensing layer ISP may detect at least one among a position and intensity (pressure) of a touch applied from the outside. The input-sensing layer ISP may have various structures or be composed of various materials, and is not limited to any one embodiment. For another example, the input-sensing layer ISP may detect an external input in a capacitive manner. The display panel DP may receive input signals from the input-sensing layer ISP and generate images corresponding to the input signals.

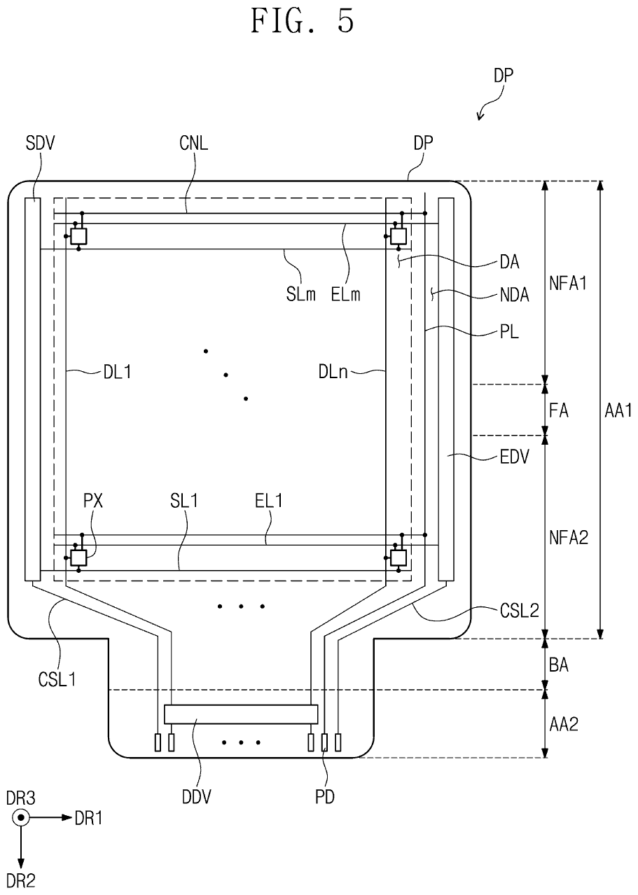

Referring to FIG. 5, a display panel DP may include pixels PX, a scan driver SDV, a data driver DDV, and an emission driver EDV.

The display panel DP may include a first region AA1, a second region AA2, and a bending region BA between the first region AA1 and the second region AA2. The first region AA1, the bending region BA, and the second region AA2 may be arranged along the second direction DR2. The bending region BA may be bent with respect to a bending axis extending along the first direction DR1 and different from the folding axis such that the second region AA2 overlaps a lower surface of the first region AA1.

According to an embodiment, the widths of the bending region BA and the second region AA2 in the first direction DR1 may be smaller than the width of the first region AA1 in the first direction DR1. Accordingly, the bending region BA may be easily bent toward the lower surface of the first region AA1.

The first region AA1 may include a display region DA and a non-display region NDA around the display region DA. The non-display region NDA may surround the display region DA. The display region DA may display images, and the non-display region NDA may not display images. The second region AA2 and the bending region BA may not display images.

The first region AA1 may include a first non-folding region NFA1, a second non-folding region NFA2, and a foldable region FA, which are arranged along the second direction DR2, the foldable region FA being disposed between the first non-folding region NFA1 and the second non-folding region NFA2. The first and the second non-folding regions NFA1 and NFA2 and the foldable region FA may correspond to the first and the second non-folding regions NFA1 and NFA2 and the foldable region FA of the electronic apparatus ED illustrated in FIG. 1A, respectively.

The first region AA1 may be bent and folded with respect to the above-described folding axes. For example, the foldable region FA of the first region AA1 is bent with respect to the above-described folding axes, and thus the display panel DP may be folded.

The display panel DP may include a plurality of pixels PX, a plurality of scan lines SL1 to SLm, a plurality of data lines DL1 to DLn, a plurality of emission lines EL1 to ELm, first and second control lines CSL1 and CSL2, a power supply line PL, a plurality of connection lines CNL, and a plurality of pads PD. m and n are natural numbers. The pixels PX may be disposed in the display region DA and be connected to the scan lines SL1 to SLm, the data lines DL1 to DLn, and the emission lines EL1 to ELm.

The scan driver SDV and the emission driver EDV may be disposed in the non-display region NDA. The scan driver SDV and the emission driver EDV may be disposed in the non-display region NDA adjacent to each of opposite sides, of the first region AA1, which are opposed to each other in the second direction DR2. The data driver DDV may be disposed in the second region AA2. The data driver DDV may be manufactured in a form of an integrated circuit chip and mounted on the second region AA2.

The scan lines SL1 to SLm may extend in the second direction DR2 to be connected to the scan driver SDV. The data lines DL1 to DLn may extend in the first direction DR1 to be connected to the data driver DDV via the bending region BA. The data driver DDV may be connected to the pixels PX via the data lines DL1 to DLn. The emission lines EL1 to ELm may extend in the second direction DR2 to be connected to the emission driver EDV.

The power supply line PL may extend in the first direction DR1 and be disposed in the non-display region NDA. The power supply line PL may be disposed between the display region DA and the emission driver EDV. The power supply line PL may extend to the second region AA2 via the bending region BA. When viewed on a plane, the power supply line PL may extend toward a lower end of the second region AA2. The power supply line PL may receive a driving voltage.

The connection lines CNL may extend in the second direction DR2 and be arranged in the first direction DR1. The connection lines CNL may be connected to the power supply line PL and the pixels PX. The driving voltage may be applied to the pixels PX via the power supply line PL and the connection lines CNL which are connected to each other.

The first control line CSL1 may be connected to the scan driver SDV and extend toward the lower end of the second region AA2 via the bending region BA. The second control line CSL2 may be connected to the emission driver EDV and extend toward the lower end of the second region AA2 via the bending region BA. The data driver DDV may be disposed between the first control line CSL1 and the second control line CSL2.

When viewed on a plane, the pads PD may be disposed adjacent to the lower end of the second region AA2. The data driver DDV, the power supply line PL, the first control line CSL1, and the second control line CSL2 may be connected to the pads PD.

The data lines DL1 to DLn may be connected to the corresponding pads PD via the data driver DDV. For example, the data lines DL1 to DLn may be connected to the data driver DDV, and the data driver DDV may be connected to the pads PD corresponding to the data lines DL1 to DLn, respectively.

Although not illustrated, a printed circuit board may be connected to the pads PD, and a timing controller and a voltage generator may be disposed on the printed circuit board. The timing controller may be manufactured as an integrated circuit chip and be mounted on the printed circuit board. The timing controller and the voltage generator may be connected to the pads PD via the printed circuit board.

The timing controller may control operations of the scan driver SDV, the data driver DDV, and the emission driver EDV. The timing controller may generate a scan control signal, a data control signal, and an emission control signal in response to control signals received from the outside. The voltage generator may generate a driving voltage.

The scan control signal may be provided to the scan driver SDV via the first control line CSL1. The emission control signal may be provided to the emission driver EDV via the second control line CSL2. The data control signal may be provided to the data driver DDV. The timing controller may receive image signals from the outside, convert data formats of the image signals so as to meet interface specifications of the data driver DDV, and provide the converted signals to the data driver DDV.

The scan driver SDV may generate a plurality of scan signals in response to a scan control signal. The scan signals may be applied to the pixels PX via the scan lines SL1 to SLm. The scan signals may be sequentially applied to the pixels PX.

The data driver DDV may generate a plurality of data voltages corresponding to image signals in response to a data control signal. The data voltages may be applied to the pixels PX via the data lines DL1 to DLn. The emission driver EDV may generate a plurality of emission signals in response to an emission control signal. The emission signals may be applied to the pixels PX via the emission lines EL1 to ELm.

The pixels PX may receive data voltages in response to the scan signals. The pixels PX may display an image by emitting light having a luminance corresponding to the data voltages in response to the emission signals. The emission time of the pixels PX may be controlled by the emission signals. The pixels PX may each include transistors, a capacitor, and a light-emitting element connected thereto. The transistors may each include a semiconductor pattern. The semiconductor pattern may include polysilicon, amorphous silicon, or a metal oxide. The semiconductor pattern may be doped with an N-type dopant or a P-type dopant. The semiconductor pattern may include a heavily doped region and a lightly doped region. The conductivity of the heavily doped region may be greater than a conductivity of the lightly doped region, and substantially serve as a source electrode and a drain electrode of the transistor. The lightly doped region may substantially correspond to an active region (or channel) of the transistor.

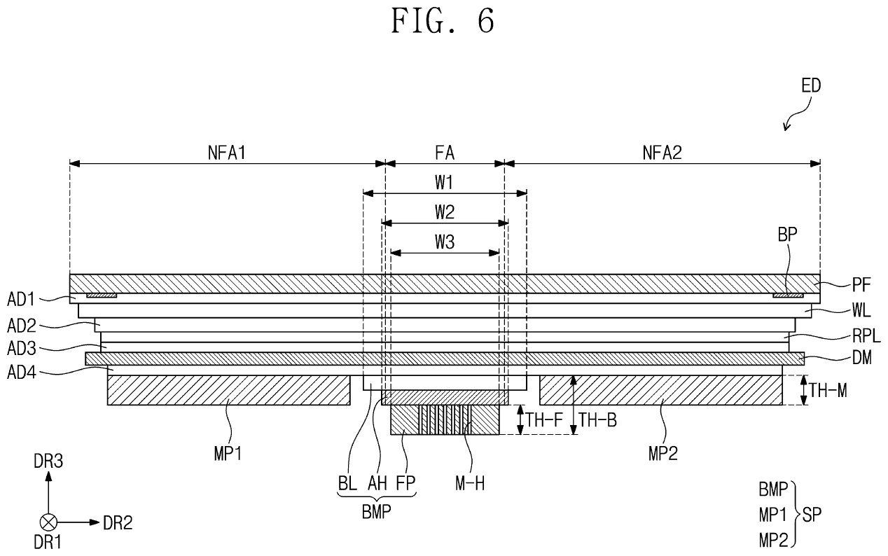

FIG. 6 is a cross-sectional view of an electronic apparatus according to an embodiment.

Referring to FIG. 6, an electronic apparatus ED according to an embodiment may include a protective layer PF, a window WL, an optical layer RPL, a display module DM, and a support plate SP. The housing HAU illustrated in FIG. 3 is omitted.

The electronic apparatus ED according to an embodiment may further include first to fourth adhesive layers AD1 to AD4. The first adhesive layer AD1 may be disposed between the window WL and the protective layer PF. The second adhesive layer AD2 may be disposed between the optical layer RPL and the window WL. The third adhesive layer AD3 may be disposed between the display module DM and the optical layer RPL. The fourth adhesive layer AD4 may be disposed between the support plate SP and the display module DM.

The support plate SP may include a first plate MP1 disposed in a first non-folding region NFA1, a second plate MP2 disposed in a second non-folding region NFA2, and a support member BMP disposed between the first plate MP1 and the second plate MP2 and overlapping a foldable region FA. The support plate SP may be disposed below the display module DM and include a function of a protective member to protect the display module DM. The foldable plate FP according to an embodiment may further include a shielding function.

The support member BMP may include a barrier layer BL, a foldable adhesive layer AH, and a foldable plate FP.

The barrier layer BL may be disposed below the display module DM. More specifically, the barrier layer BL may be in contact with the fourth adhesive layer AD4 overlapping the foldable region FA. The barrier layer BL may increase resistance against a compressive force caused by external pressure. Accordingly, the barrier layer BL may serve to prevent deformation of the display panel DP overlapping the foldable region FA. In an embodiment, the barrier layer BL may be bendable while an elastic modulus of the barrier layer BL may be higher than elastic modulus of other elements in the foldable region FA.

According to an embodiment, one end of the barrier layer BL may overlap the first non-folding region NFA1, and the other end of the barrier layer BL may overlap the second non-folding region NFA2. The remaining portion, of the barrier layer BL, disposed between the one end and the other end, may be disposed in the foldable region FA.

The barrier layer BL may include a flexible plastic material such as polyimide or polyethylene terephthalate. Additionally, the barrier layer BL may be a colored film having low light transmittance. The barrier layer BL may absorb light incident from the outside. For example, the barrier layer BL may be a black synthetic resin film. When the display module DM is viewed from above the window protective layer PF, components disposed below the barrier layer BL may be invisible to a user.

The foldable adhesive layer AH may be disposed under the barrier layer BL. The foldable adhesive layer AH may include a typical bonding agent such as a pressure sensitive adhesive (PSA), an optically clear adhesive (OCA), and an optical clear resin (OCR), and is not limited to any one embodiment.

The foldable plate FP may be disposed under the foldable adhesive layer AH. According to this embodiment, in the foldable plate FP, holes M-H penetrating from a front surface to a lower surface of the foldable plate FP may be defined. Since the foldable plate FP defines the holes M-H therein, the foldable plate FP may be easily deformed during the folding operation of the electronic apparatus ED.

According to this embodiment, the first and second plates MP1 and MP2, and the foldable plate FP may include the same material. For example, the first and second plates MP1 and MP2, and the foldable plate FP may include metal. For example, the metal may be either of stainless steel or aluminum. The first and second plates MP1 and MP2 and the foldable plate FP may include a matrix including fillers, and woven fiber lines disposed within the matrix. The fiber lines may be arranged in a fabric form within the matrix.

The fiber lines may include a reinforced fiber composite material. The reinforced fiber composite material may be either of a carbon fiber-reinforced plastic (“CFRP”) or a glass fiber-reinforced plastic (“GFRP”). One strand of fiber included in one fiber line may have a diameter of about 3 micrometers (μm) to about 10 μm.

The matrix according to an embodiment may include at least one of epoxy, polyester, polyamide, polycarbonate, polypropylene, polybutylene, or vinyl ester.

The matrix may include a filler. The filler may include at least one of silica, barium sulphate, sintered talc, barium titanate, titanium oxide, clay, alumina, mica, boehmite, zinc borate, or zinc stannate.

The first and second plates MP1 and MP2 may each have a first thickness TH-M, and the foldable plate FP may have a second thickness TH-F. According to an embodiment, the first thickness TH-M may be greater than or equal to the second thickness TH-F. Accordingly, a total thickness TH-B of the support member BMP (i.e., a maximum thickness of the support member BMP) may be greater than the first thickness TH-M.

According to the invention, in the second direction DR2, the barrier layer BL may have a first width W1, the foldable adhesive layer AH may have a second width W2, and the foldable plate FP may have a third width W3. The second width W2 may be smaller than the first width W1 and greater than the third width W3. Accordingly, the foldable plate FP may expose a portion of a rear surface of the foldable adhesive layer AH, and the foldable adhesive layer AH may expose a portion of a rear surface of the barrier layer BL. The description of the width illustrated above may be commonly applied to embodiments of the electronic apparatus to be described later.

According to Comparative Example, in the case in which widths of the barrier layer, the foldable adhesive layer, and the foldable plates in the second direction DR2 are the same, respective ends of the barrier layer, the foldable adhesive layer, and the foldable plates overlap each other during the folding operation of the electronic apparatus according to Comparative Example, and thus stress may concentrate on the rear surface of the display module. Accordingly, cracks may occur in the rear surface of the display module may occur.

In contrast, according to the invention, components disposed on the support member BMP have different widths from one another, and the widths of the components gradually decrease in the direction away from the display module DM (e.g., the second width W2 may be smaller than the first width W1 and greater than the third width W3), and thus it is possible to effectively prevent stress concentration on the rear surface of the display module DM caused by the ends of the barrier layer BL during the folding operation of the electronic apparatus ED.

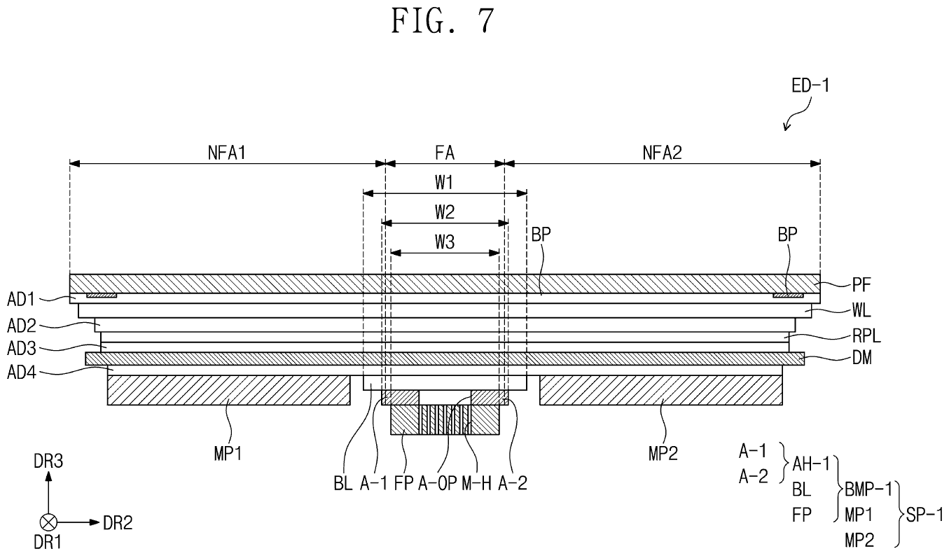

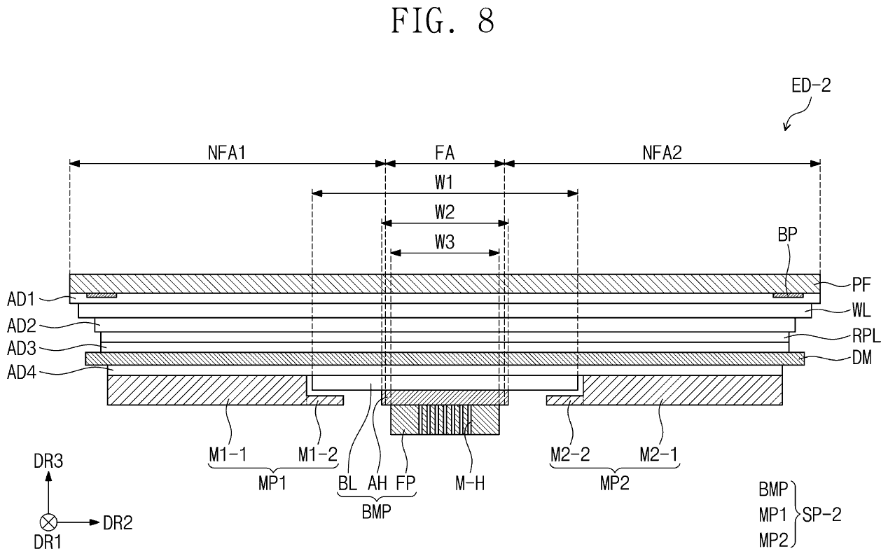

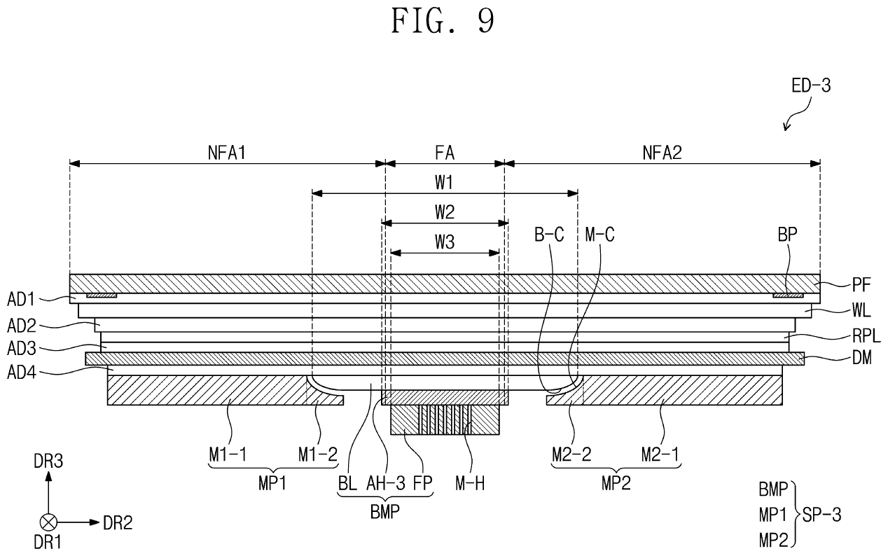

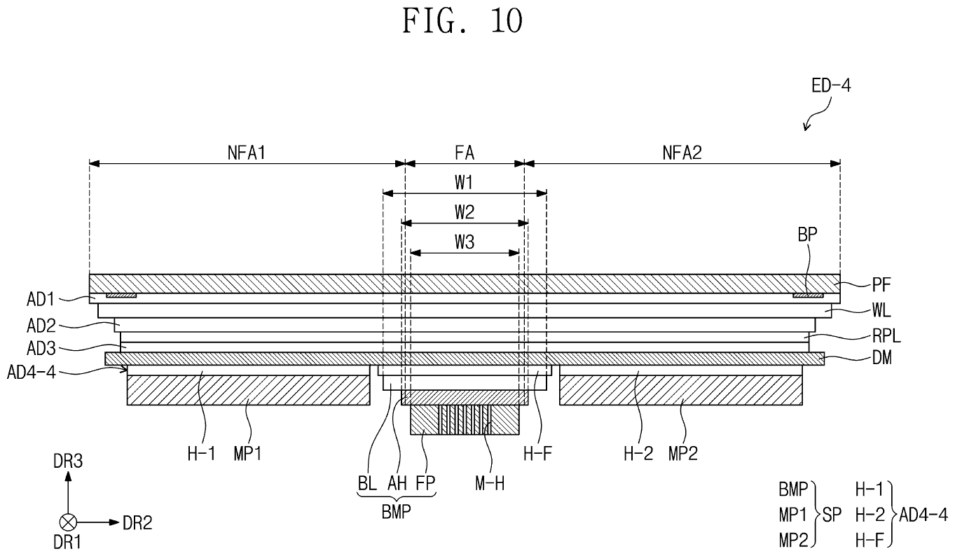

FIG. 7 is a cross-sectional view of an electronic apparatus according to another embodiment. FIG. 8 is a cross-sectional view of an electronic apparatus according to still another embodiment. FIG. 9 is a cross-sectional view of an electronic apparatus according to yet another embodiment. FIG. 10 is a cross-sectional view of an electronic apparatus according to still another embodiment. The same/similar reference numerals or symbols are used for the components same/similar to those described in FIGS. 1A to 6, and a duplicated description thereof will be omitted.

Referring to FIG. 7, an electronic apparatus ED-1 according to an embodiment may include a protective layer PF, a window WL, an optical layer RPL, a display module DM, and a support plate SP-1. The electronic apparatus ED-1 according to an embodiment may further include first to fourth adhesive layers AD1 to AD4. The housing HAU illustrated in FIG. 3 is omitted.

The support plate SP-1 may include a first plate MP1 disposed in a first non-folding region NFA1, a second plate MP2 disposed in a second non-folding region NFA2, and a support member BMP-1 disposed between the first plate MP1 and the second plate MP2 and overlapping a foldable region FA.

The support member BMP-1 may include a barrier layer BL, a foldable adhesive layer AH-1, and a foldable plate FP.

The barrier layer BL may be disposed below the display module DM. More specifically, the barrier layer BL may be in contact with the fourth adhesive layer AD4 overlapping the foldable region FA. One end of the barrier layer BL may overlap the first non-folding region NFA1, and the other end of the barrier layer BL may overlap the second non-folding region NFA2. The remaining portion, of the barrier layer BL, disposed between the one end and the other end may be disposed in the foldable region FA.

The foldable plate FP may be disposed under the foldable adhesive layer AH-1. According to this embodiment, in the foldable plate FP, holes M-H penetrating from a front surface to a lower surface of the foldable plate FP may be defined. Since the foldable plate FP defines the holes M-H therein, the foldable plate FP may be easily deformed during the folding operation of the electronic apparatus ED-1.

The foldable adhesive layer AH-1 may be disposed between the barrier layer BL and the foldable plate FP. The foldable adhesive layer AH-1 according to this embodiment may include a first portion A-1 and a second portion A-2. The first portion A-1 may be spaced apart from the holes M-H and disposed adjacent to the first non-folding region NFA1. The second portion A-2 may be spaced apart from the holes M-H and disposed adjacent to the second non-folding region NFA2 in a plan view. That is, a portion of a rear surface of the barrier layer BL and the holes M-H may be exposed by the first portion A-1 and the second portion A-2.

The electronic apparatus ED-1 according to this embodiment may more easily perform a folding operation since the foldable adhesive layer AH-1 includes the first portion A-1 and the second portion A-2 spaced apart from the holes M-H defined in the foldable plate FP in a plan view.

The foldable adhesive layer AH-1 may include a typical bonding agent such as a pressure sensitive adhesive (PSA), an optically clear adhesive (OCA), and an optical clear resin (OCR), and is not limited to any one embodiment.

According to this embodiment, in the second direction DR2, the barrier layer BL may have a first width W1, the foldable adhesive layer AH-1 may have a second width W2, and the foldable plate FP may have a third width W3. The second width W2 may be smaller than the first width W1 and greater than the third width W3.

Referring to FIG. 8, an electronic apparatus ED-2 according to an embodiment may include a protective layer PF, a window WL, an optical layer RPL, a display module DM, and a support plate SP-2. The electronic apparatus ED-2 according to an embodiment may further include first to fourth adhesive layers AD1 to AD4. The housing HAU illustrated in FIG. 3 is omitted.

The support plate SP-2 may include a first plate MP1 disposed in a first non-folding region NFA1, a second plate MP2 disposed in a second non-folding region NFA2, and a support member BMP disposed between the first plate MP1 and the second plate MP2 and overlapping a foldable region FA.

The support member BMP may include a barrier layer BL, a foldable adhesive layer AH, and a foldable plate FP.

The barrier layer BL may be disposed below the display module DM. More specifically, the barrier layer BL may be in contact with the fourth adhesive layer AD4 overlapping the foldable region FA. One end of the barrier layer BL may overlap the first non-folding region NFA1, and the other end of the barrier layer BL may overlap the second non-folding region NFA2. The remaining portion, of the barrier layer BL, disposed between the one end and the other end may be disposed in the foldable region FA.

The foldable adhesive layer AH may be disposed between the barrier layer BL and the foldable plate FP. The foldable adhesive layer AH may include a typical bonding agent such as a pressure sensitive adhesive (PSA), an optically clear adhesive (OCA), and an optical clear resin (OCR), and is not limited to any one embodiment.

The foldable plate FP may be disposed under the foldable adhesive layer AH. According to this embodiment, in the foldable plate FP, holes M-H penetrating from a front surface to a lower surface of the foldable plate FP may be defined. The foldable plate FP defines the holes M-H therein, and thus the foldable plate FP may be easily deformed during the folding operation of the electronic apparatus ED.

According to this embodiment, in the second direction DR2, the barrier layer BL may have a first width W1, the foldable adhesive layer AH may have a second width W2, and the foldable plate FP may have a third width W3. The second width W2 may be smaller than the first width W1 and greater than the third width W3.

According to this embodiment, the first plate MP1 may include a (1-1)-th portion M1-1 having a first thickness, and a (1-2)-th portion M1-2 protruding from the (1-1)-th portion M1-1 toward a boundary between the first non-folding region NFA1 and the foldable region FA and having a second thickness.

The (1-1)-th portion M1-1 may be in contact with the foldable adhesive layer AH, and the (1-2)-th portion M1-2 may be spaced apart from the foldable adhesive layer AH in a plan view. A first stepped portion having a predetermined space defined therein may be defined by the (1-1)-th portion M1-1 and the (1-2)-th portion M1-2.

The second plate MP2 may include a (2-1)-th portion M2-1 having a first thickness, and a (2-2)-th portion M2-2 protruding from the (2-1)-th portion M2-1 toward a boundary between the second non-folding region NFA2 and the foldable region FA and having a second thickness.

The (2-1)-th portion M2-1 may be in contact with the foldable adhesive layer AH, and the (2-2)-th portion M2-2 may be spaced apart from the foldable adhesive layer AH in a plan view. A second stepped portion having a predetermined space defined therein may be defined by the (2-1)-th portion M2-1 and the (2-2)-th portion M2-2.

According to this embodiment, a portion, of one end of the barrier layer BL, overlapping the first non-folding region NFA1 may be disposed in an inner space defined by the first stepped portion. Additionally, a portion, of the other end of the barrier layer BL, overlapping the second non-folding region NFA2 may be disposed in an inner space defined by the second stepped portion.

Referring to FIG. 9, an electronic apparatus ED-3 according to an embodiment may include a protective layer PF, a window WL, an optical layer RPL, a display module DM, and a support plate SP-3. The electronic apparatus ED-3 according to an embodiment may further include first to fourth adhesive layers AD1 to AD4. The housing HAU illustrated in FIG. 3 is omitted.

The support plate SP-3 may include a first plate MP1 disposed in a first non-folding region NFA1, a second plate MP2 disposed in a second non-folding region NFA2, and a support member BMP disposed between the first plate MP1 and the second plate MP2 and overlapping a foldable region FA.

The support member BMP may include a barrier layer BL, a foldable adhesive layer AH-3, and a foldable plate FP.

The barrier layer BL may be disposed below the display module DM. More specifically, the barrier layer BL may be in contact with the fourth adhesive layer AD4 overlapping the foldable region FA. One end of the barrier layer BL may overlap the first non-folding region NFA1, and the other end of the barrier layer BL may overlap the second non-folding region NFA2. The remaining portion, of the barrier layer BL, disposed between the one end and the other end may be disposed in the foldable region FA.

The foldable adhesive layer AH-3 may be disposed between the barrier layer BL and the foldable plate FP. The foldable adhesive layer AH-3 may include a typical bonding agent such as a pressure sensitive adhesive (PSA), an optically clear adhesive (OCA), and an optical clear resin (OCR), and is not limited to any one embodiment.

The foldable plate FP may be disposed under the foldable adhesive layer AH-3. According to this embodiment, in the foldable plate FP, holes M-H penetrating from a front surface to a lower surface of the foldable plate FP may be defined. The foldable plate FP defines the holes M-H therein, and thus the foldable plate FP may be easily deformed during the folding operation of the electronic apparatus ED.

According to this embodiment, in the second direction DR2, the barrier layer BL may have a first width W1, the foldable adhesive layer AH-3 may have a second width W2, and the foldable plate FP may have a third width W3. The second width W2 may be smaller than the first width W1 and greater than the third width W3.

According to this embodiment, the first plate MP1 may include a (1-1)-th portion M1-1 having a first thickness, and a (1-2)-th portion M1-2 protruding from the (1-1)-th portion M1-1 toward a boundary between the first non-folding region NFA1 and the foldable region FA and having a second thickness.

The (1-1)-th portion M1-1 may be in contact with the foldable adhesive layer AH-3, and the (1-2)-th portion M1-2 may be spaced apart from the foldable adhesive layer AH-3 in a plan view. A first stepped portion having a predetermined space defined therein may be defined by the (1-1)-th portion M1-1 and the (1-2)-th portion M1-2.

The second plate MP2 may include a (2-1)-th portion M2-1 having a first thickness, and a (2-2)-th portion M2-2 protruding from the (2-1)-th portion M2-1 toward a boundary between the second non-folding region NFA2 and the foldable region FA and having a second thickness.

The (2-1)-th portion M2-1 may be in contact with the foldable adhesive layer AH-3, and the (2-2)-th portion M2-2 may be spaced apart from the foldable adhesive layer AH-3 in a plan view. A second stepped portion having a predetermined space defined therein may be defined by the (2-1)-th portion M2-1 and the (2-2)-th portion M2-2.

According to this embodiment, a portion overlapping the first non-folding region NFA1 among one end of the barrier layer BL may be disposed in an inner space defined by the first stepped portion. Additionally, a portion overlapping the second non-folding region NFA2 among the other end of the barrier layer BL may be disposed in an inner space defined by the second stepped portion.

According to this embodiment, the (1-2)-th portion M1-2 may have a curved surface recessed from the display module DM toward the first plate MP1. Additionally, the (2-2)-th portion M2-2 may have a curved surface recessed from the display module DM toward the second plate MP2.

One end of the barrier layer BL according to an embodiment may be curved so as to correspond to a shape of the curved surface of the (1-2)-th portion M1-2, and the other end of the barrier layer BL may be curved so as to correspond to a shape of the curved surface of the (2-2)-th portion M2-2.

Referring to FIG. 10, an electronic apparatus ED-4 according to an embodiment may include a protective layer PF, a window WL, an optical layer RPL, a display module DM, and a support plate SP. The electronic apparatus ED-4 according to an embodiment may further include first to fourth adhesive layers AD1 to AD4-4. The housing HAU illustrated in FIG. 3 is omitted.

The support plate SP may include a first plate MP1 disposed in a first non-folding region NFA1, a second plate MP2 disposed in a second non-folding region NFA2, and a support member BMP disposed between the first plate MP1 and the second plate MP2 and overlapping a foldable region FA. The support member BMP may include a barrier layer BL, a foldable adhesive layer AH-3, and a foldable plate FP.

The fourth adhesive layer AD4-4 (or in-between adhesive layer) according to this embodiment may be disposed between the display module DM and the support plate SP. The fourth adhesive layer AD4-4 may include a first portion H-1 overlapping the first plate MP1, a second portion H-2 overlapping the second plate MP2, and a foldable portion H-F disposed between the first portion H-1 and the second portion H-2 and spaced apart from the first portion H-1 and the second portion H-2 in a plan view when unfolded.

According to this embodiment, in the second direction DR2, the width of the foldable portion H-F may be greater than the width of the barrier layer BL. Accordingly, a portion of a rear surface of the foldable portion H-F may be exposed from the barrier layer BL.

According to an embodiment of the invention, stress may be prevented from concentrating on a rear surface of a display module during folding, thereby preventing cracks from occurring in the display module. Therefore, it is possible to provide an electronic apparatus with improved reliability.

Although the embodiments of the invention have been described, it is understood that the invention should not be limited to these embodiments but various changes and modifications can be made by one ordinary skilled in the art within the spirit and scope of the invention as hereinafter claimed.

Therefore, the technical scope of the invention is not limited to the contents described in the detailed description of the specification, but should be determined by the claims.

What is claimed is:

1. An electronic apparatus comprising:
a display module including a foldable region foldable with respect to a folding axis extending along a first direction, and a first non-folding region and a second non-folding region which are spaced apart along a second direction crossing the first direction with the foldable region therebetween;
a window disposed on the display module; and
a support plate disposed below the display module, and including a first plate overlapping the first non-folding region, a second plate overlapping the second non-folding region, and a support member overlapping the foldable region,
wherein the support member includes
a barrier layer disposed below the display module,
a foldable adhesive layer disposed under the barrier layer, and
a foldable plate disposed under the foldable adhesive layer, and
a width of the foldable adhesive layer in the second direction is smaller than a width of the barrier layer, and greater than a width of the foldable plate.

2. The electronic apparatus of claim 1, wherein the foldable plate provides a plurality of holes defined therein, which penetrates from a front surface and to a rear surface of the foldable plate.

3. The electronic apparatus of claim 1, wherein the foldable adhesive layer comprises:
a first portion disposed adjacent to the first non-folding region and not overlapping the plurality of holes; and
a second portion spaced apart from the first portion with the plurality of holes therebetween and disposed adjacent to the second non-folding region.

4. The electronic apparatus of claim 1, wherein the first plate, the second plate, and the foldable plate comprise one of a metal and a reinforced fiber composite material.

5. The electronic apparatus of claim 1, wherein one end of the barrier layer overlaps the first non-folding region, and an opposite end of the barrier layer in the second direction overlaps the second non-folding region.

6. The electronic apparatus of claim 1, wherein the first plate comprises a first portion having a first thickness, and a second portion which protrudes from the first portion toward a boundary between the first non-folding region and the foldable region and has a second thickness smaller than the first thickness,
the second plate comprises a third portion having the first thickness, and a fourth portion which protrudes from the third portion toward a boundary between the second non-folding region and the foldable region and has the second thickness,
a first stepped portion is defined by the first portion and the second portion, and a second stepped portion is defined by the third portion and the fourth portion, and
one end of the barrier layer is disposed inside the first stepped portion, and an opposite end of the barrier layer in the second direction is disposed inside the second stepped portion.

7. The electronic apparatus of claim 6, wherein the second portion, which faces the one end, and the fourth portion, which faces the opposite end, have curved surfaces, respectively, and
the one end and the opposite end of the barrier layer, which face the curved surfaces, are curved so as to correspond to the curved surfaces.

8. The electronic apparatus of claim 1, further comprising an in-between adhesive layer disposed between the display module and the support plate.

9. The electronic apparatus of claim 8, wherein the in-between adhesive layer comprises:
a first portion overlapping the first plate;
a second portion overlapping the second plate, and
a foldable portion disposed between the first portion and the second portion and spaced apart from the first portion and the second portion.

10. The electronic apparatus of claim 9, wherein a width of the foldable portion in the second direction is smaller than a width of the barrier layer.

11. The electronic apparatus of claim 1, wherein the folding axis is defined on an upper surface of the window, and
the electronic apparatus is configured to be in-folded such that a part of the upper surface of the window overlapping the first non-folding region and a part of the upper surface of the window overlapping the second non-folding region face each other in a first mode, and face a same direction in a second mode.

12. The electronic apparatus of claim 1, wherein the folding axis is defined below a rear surface of the support plate, and
the electronic apparatus is configured to be in-folded such that a rear surface of the first plate and a rear surface of the second plate face each other in a first mode and face a same direction in a second mode.

13. The electronic apparatus of claim 1, further comprising an optical layer disposed between the window and the display module,
wherein the optical layer includes at least one of a retarder, a polarizer, a polarization film, a polarization filter, or a color filter.

14. The electronic apparatus of claim 1, wherein the display module comprises:
a display panel including pixels; and
an input-sensing layer disposed on the display panel.

15. The electronic apparatus of claim 14, wherein the display panel comprises a base layer, a circuit layer disposed on the base layer, a display element layer disposed on the circuit layer, and an encapsulation layer covering the display element layer, and
the input-sensing layer is directly disposed on the encapsulation layer.

16. The electronic apparatus of claim 14, wherein the display panel comprises:
a first region overlapping the first non-folding region, the foldable region, and the second non-folding region;
a second region arranged along the second direction with the first region; and
a bending region disposed between the first region and the second region, and
wherein the bending region is bent with respect to a bending axis extending along the first direction and different from the folding axis.

17. The electronic apparatus of claim 1, wherein the barrier layer comprises a flexible plastic material.

18. The electronic apparatus of claim 1, wherein the foldable adhesive layer comprises at least one of a pressure sensitive adhesive (PSA), an optically clear adhesive (OCA), or an optical clear resin (OCR).

19. The electronic apparatus of claim 1, wherein a maximum thickness of the support member is greater than each of thicknesses of the first plate and the second plate.

20. The electronic apparatus of claim 1, wherein a thickness of the foldable plate is the same as each of thicknesses of the first plate and the second plate.
